(19) United States
(12) Patent Application Publication
(10) Pub. No.: US 2025/0253629 A1
(43) Pub. Date: Aug. 7, 2025

(54) PROTECTOR AND BUSBAR MODULE

(71) Applicant: Yazaki Corporation, Tokyo (JP)

(72) Inventor: Katsunori SATO, Shizuoka (JP)

(73) Assignee: Yazaki Corporation, Tokyo (JP)

(21) Appl. No.: 19/004,788

(22) Filed: Dec. 30, 2024

(30) Foreign Application Priority Data
Feb. 1, 2024 (JP) 2024-014170

(51) Int. Cl. H02G 3/04; H02G 5/06

(52) U.S. Cl. CPC H02G 3/0437; H02G 5/06

(57) ABSTRACT

A protector includes: a first case including a first passage through which a first portion of a flat wiring member is routed; a second case including a second passage through which a second portion of the flat wiring member is routed; and a rotating structure configured to be able to rotate the second case relative to the first case. The second case holds the second portion so as to form a folded portion between the first portion and the second portion, and the rotating structure is configured such that rotation of the second case relative to the first case changes an intersection angle of the second portion with respect to the first portion at the folded portion.

### CROSS-REFERENCE TO RELATED APPLICATION(S)

The present application claims priority to and incorporates by reference the entire contents of Japanese Patent Application No. 2024-014170 filed in Japan on Feb. 1, 2024.

### BACKGROUND OF THE INVENTION

### 1. Field of the Invention

The present invention relates to a protector and a busbar module.

### 2. Description of the Related Art

There is a known technique of connecting a connector connected to a flat wiring member to a mating connector. Japanese Patent Application Laid-open No. 2020-021595 discloses a circuit body with a connector, the circuit body with a connector including: a circuit body including a flexible substrate provided with a wiring pattern; and a connector attached to the circuit body.

In a configuration of protecting a flat wiring member by the protector, it is desirable to be able to handle the situation in which the mating connector is located at an irregular relative position with respect to the protector. For example, with a capability to change the direction in which the flat wiring member extends from the protector, a common protector can be applied to mating connectors at irregular positions.

### SUMMARY OF THE INVENTION

An object of the present invention is to provide a protector and a busbar module capable of changing an extension direction of a flat wiring member.

In order to achieve the above mentioned object, a protector according to one aspect of the present invention includes a first case including a first passage through which a first portion of a flat wiring member is routed; a second case including a second passage through which a second portion of the flat wiring member is routed; and a rotating structure configured to be able to rotate the second case relative to the first case, wherein the second case holds the second portion so as to form a folded portion between the first portion and the second portion, and the rotating structure is configured such that rotation of the second case relative to the first case changes an intersection angle of the second portion with respect to the first portion at the folded portion.

In order to achieve the above mentioned object, a busbar module according to another aspect of the present invention includes the protector; the flat wiring member; a connector connected to the flat wiring member; and a plurality of busbars connected to the flat wiring member and connectable to an electrode of a battery cell.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a busbar module according to an embodiment;

FIG. 2 is a perspective view of a protector according to the embodiment;

FIG. 3 is a perspective view of the protector according to the embodiment;

FIG. 4 is an exploded perspective view of the protector according to the embodiment;

FIG. 5 is a plan view of a second case according to the embodiment;

FIG. 6 is a plan view of the protector according to the embodiment;

FIG. 7 is a plan view of the protector according to the embodiment;

FIG. 8 is a cross-sectional view of the protector according to the embodiment;

FIG. 9 is a plan view of the protector according to the embodiment;

FIG. 10 is a view illustrating deformation of a folded portion;

FIG. 11 is a view illustrating deformation of the folded portion;

FIG. 12 is an exploded perspective view of another protector according to the embodiment;

FIG. 13 is a perspective view of another first case according to the embodiment;

FIG. 14 is a plan view of the another first case according to the embodiment;

FIG. 15 is a plan view of the another protector according to the embodiment;

FIG. 16 is a plan view of the another protector according to the embodiment;

FIG. 17 is a plan view illustrating an example of a second case according to the embodiment; and

FIG. 18 is a plan view illustrating an example of a first case according to the embodiment.

### DETAILED DESCRIPTION OF THE PREFERRED EMBODIMENTS

Hereinafter, a protector and a busbar module according to an embodiment of the present invention will be described in detail with reference to the drawings. Note that the present invention is not limited by the embodiment. Moreover, components in the following embodiment include those that are easily conceivable for those skilled in the art or substantially identical.

### EMBODIMENT

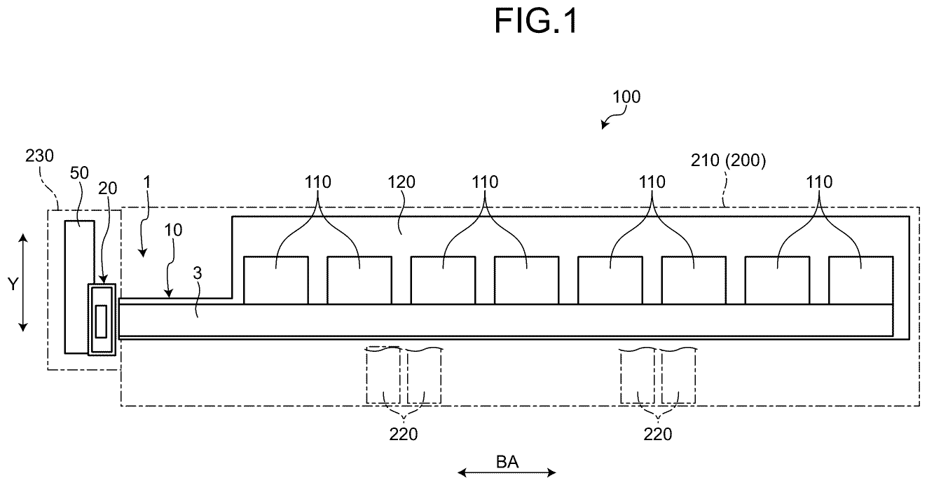

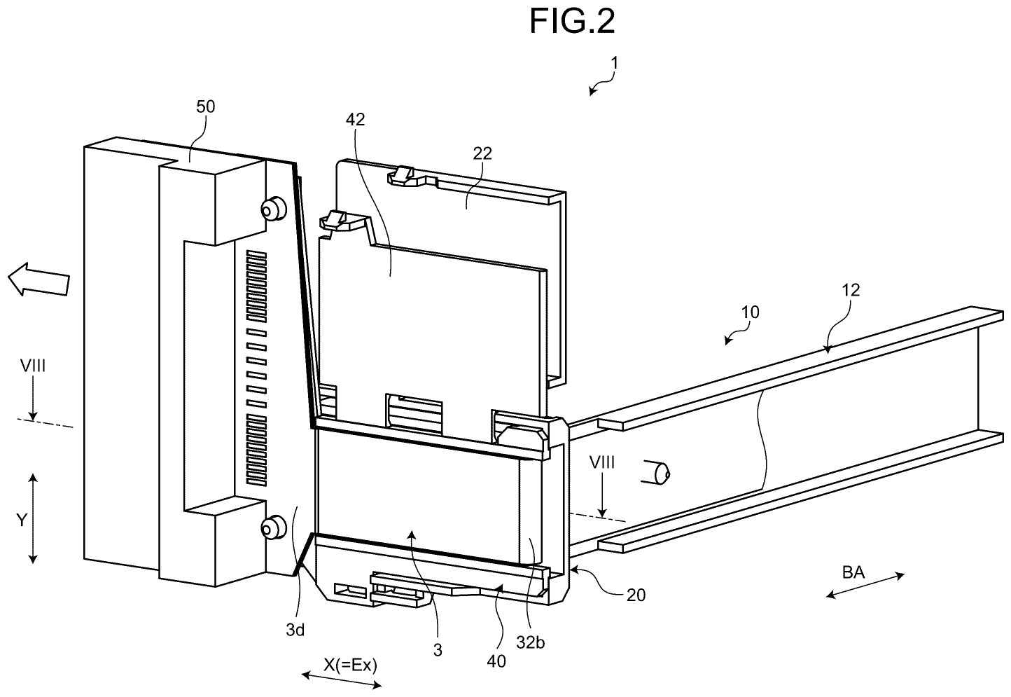

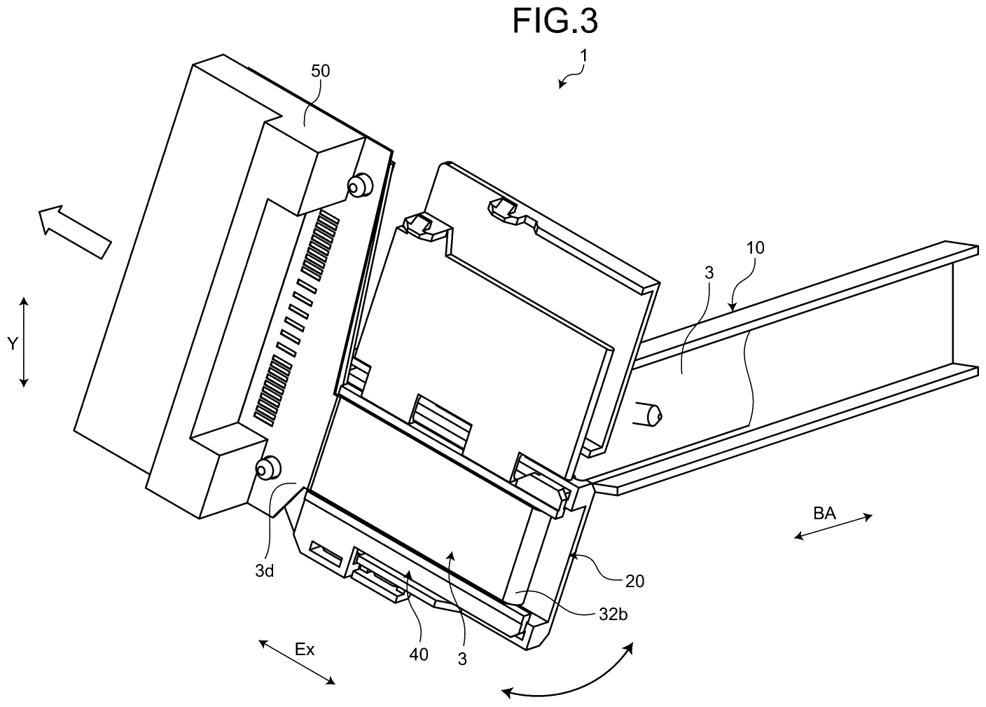

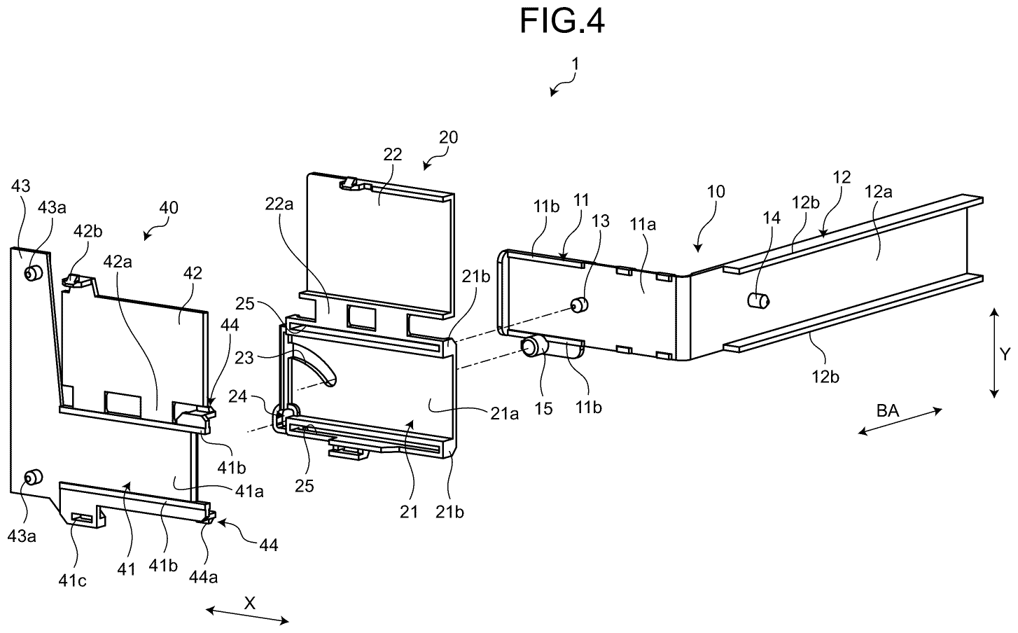

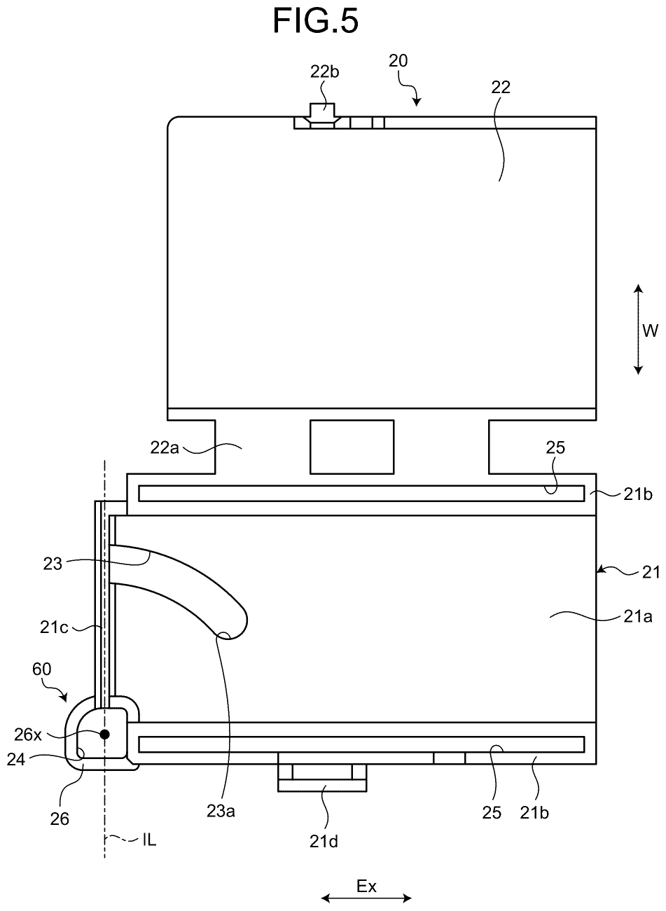

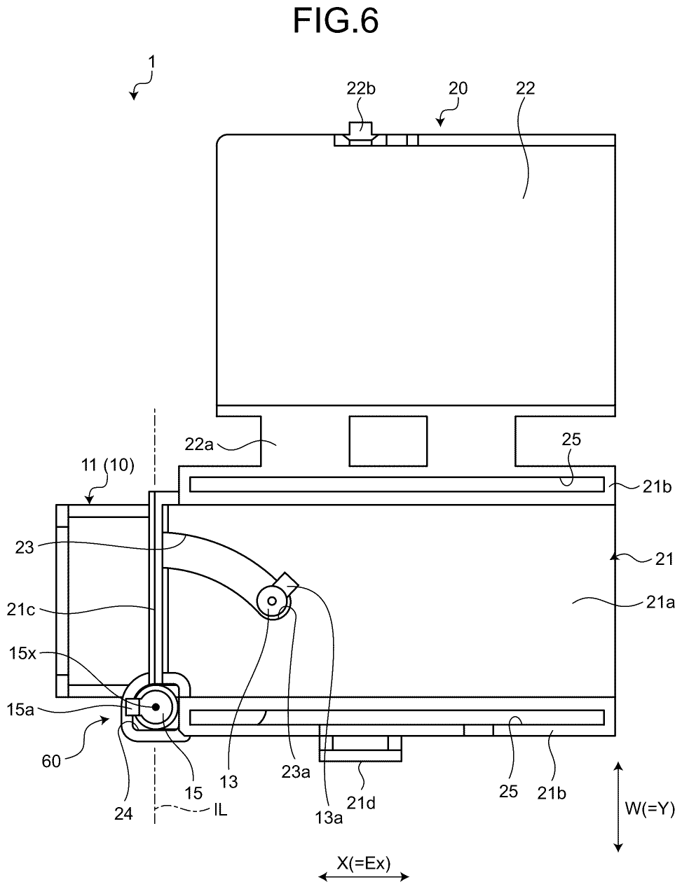

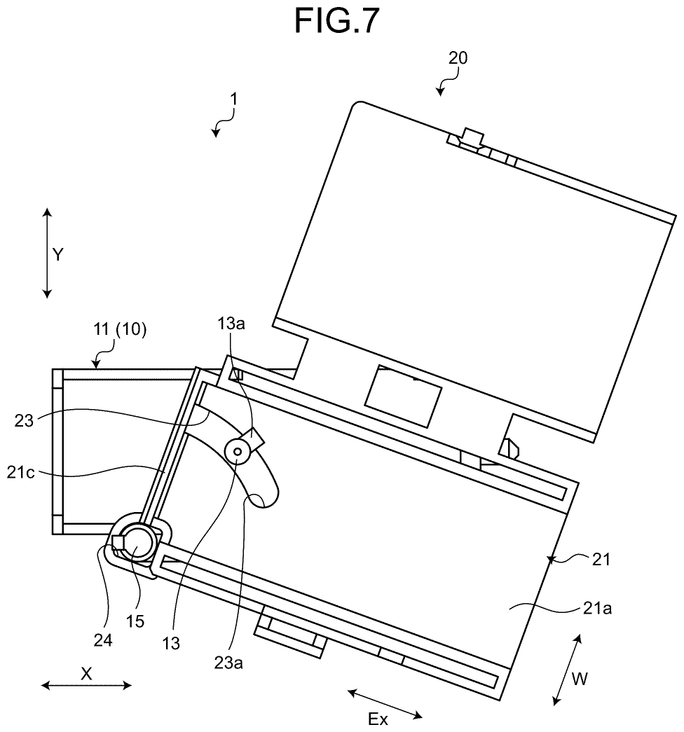

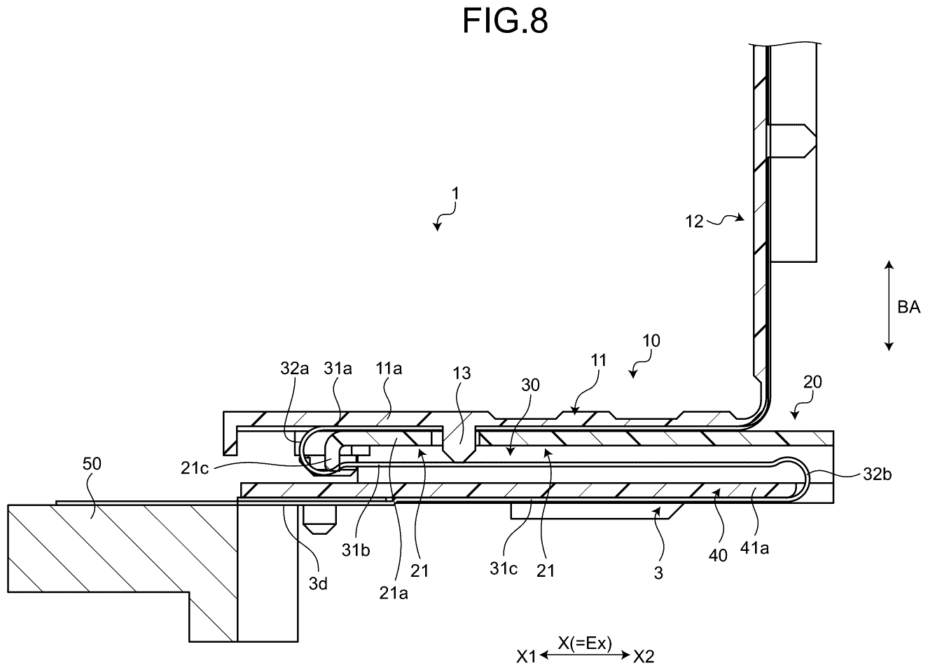

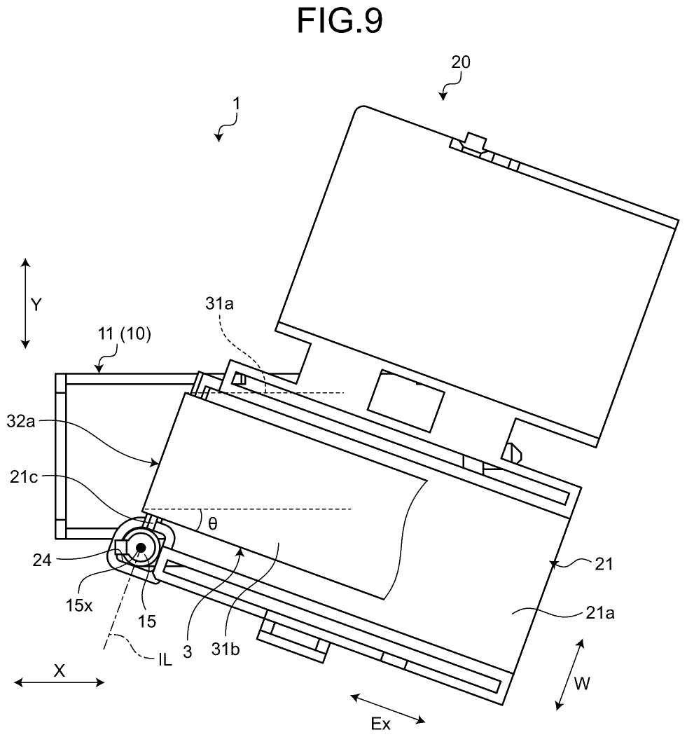

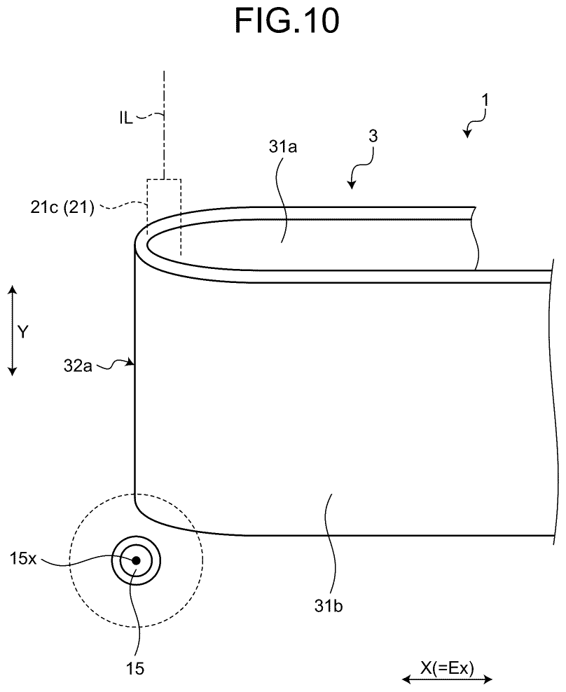

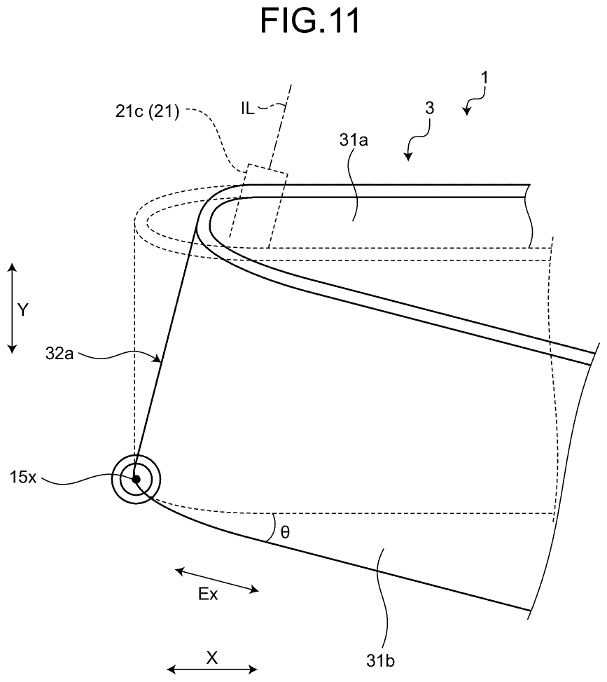

An embodiment will be described with reference to FIGS. 1 to 18. The present embodiment relates to a protector and a busbar module. FIG. 1 is a plan view of a busbar module according to an embodiment; FIGS. 2 and 3 are perspective views of a protector according to the embodiment; FIG. 4 is an exploded perspective view of the protector according to the embodiment; FIG. 5 is a plan view of a second case according to the embodiment; FIGS. 6 and 7 are plan views of the protector according to the embodiment; FIG. 8 is a cross-sectional view of the protector according to the embodiment; FIG. 9 is a plan view of the protector according to the embodiment; and FIGS. 10 and 11 are views illustrating deformation of a folded portion.

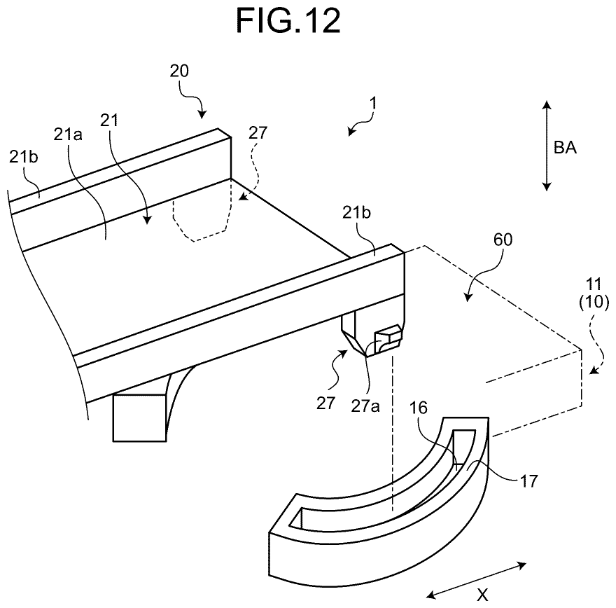

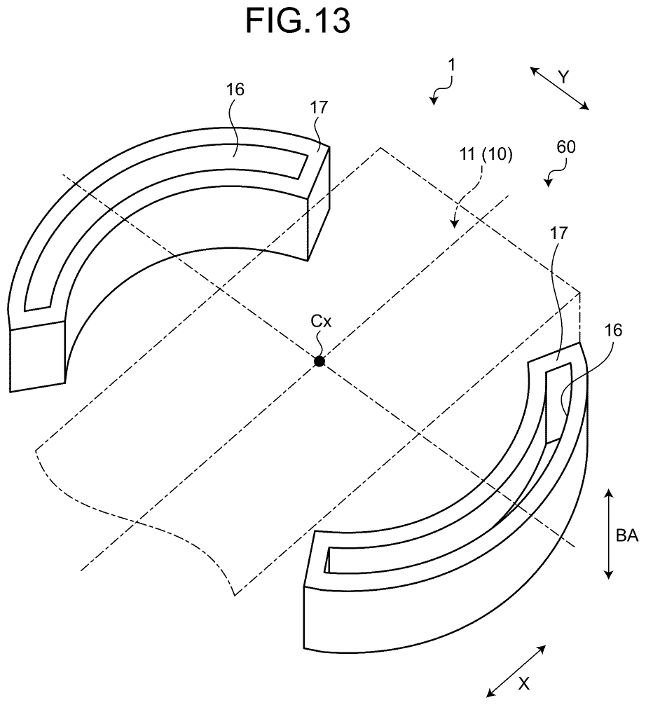

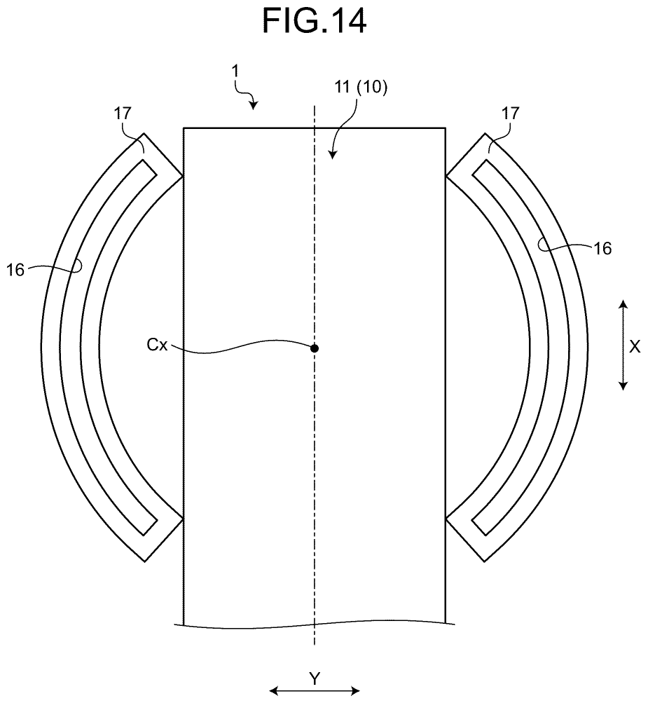

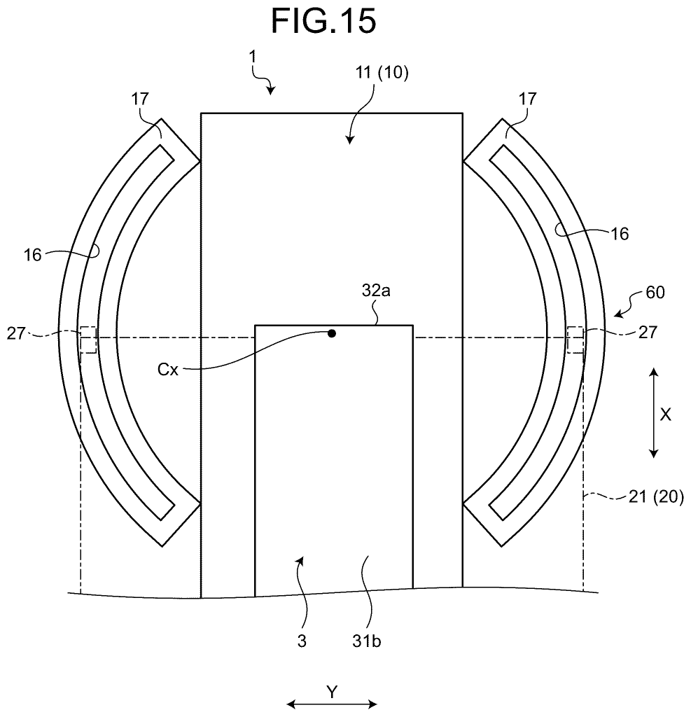

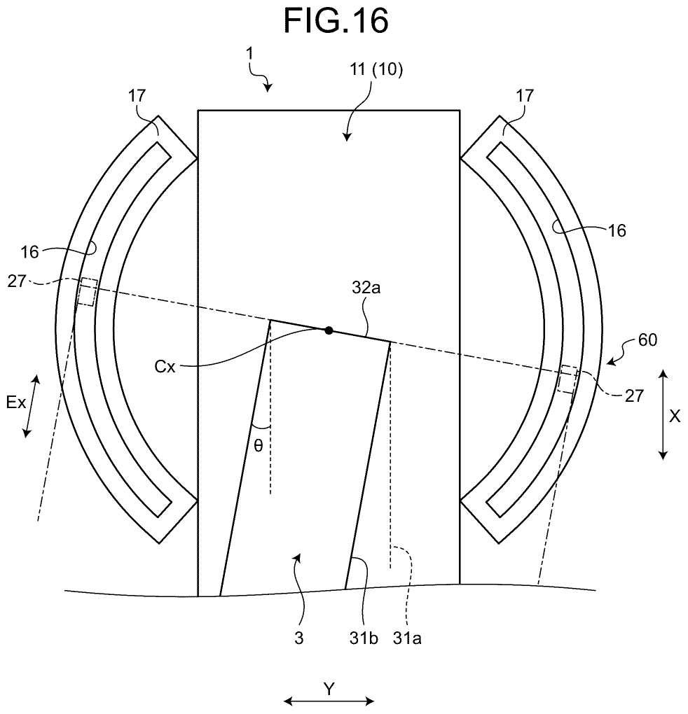

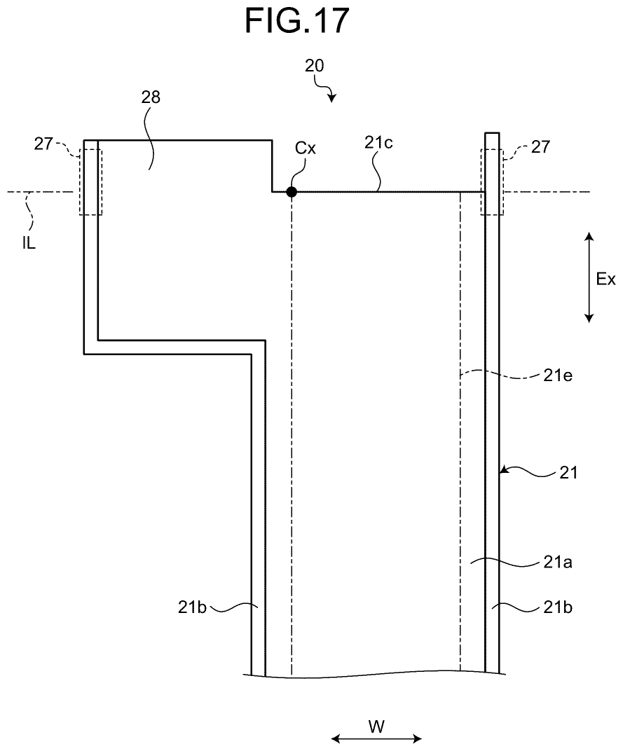

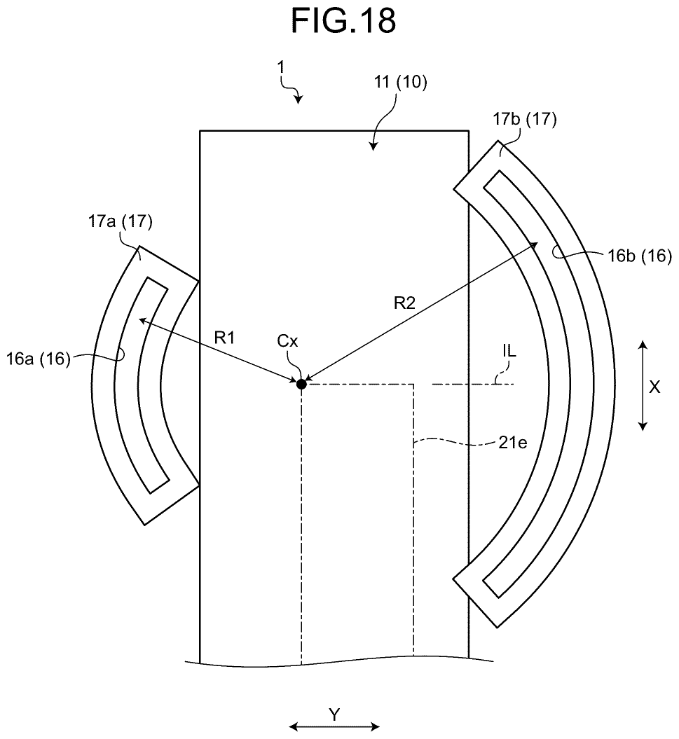

FIG. 12 is an exploded perspective view of another protector according to the embodiment; FIG. 13 is a perspective view of another first case according to the embodiment; FIG. 14 is a plan view of the another first case according to the embodiment; FIGS. 15 and 16 are plan views of the another protector according to the embodiment; FIG. 17 is a plan view illustrating an example of a second case according to the embodiment; and FIG. 18 is a plan view illustrating an example of the first case according to the embodiment. FIG. 8 illustrates a cross section taken along line VIII-VIII of FIG. 2.

A protector 1 of the present embodiment is a protective member that protects a flat wiring member 3. The flat wiring member 3 is a flexible flat plate-shaped wiring member, and is, for example, a flexible printed circuit board. The flat wiring member 3 may be another flat plate-shaped wiring member such as a flexible flat cable.

The protector 1 of the present embodiment constitutes a part of a busbar module 100, for example. The busbar module 100 is assembled to a battery module 210 of a battery pack 200. The battery module 210 includes a plurality of battery cells 220. The plurality of battery cells 220 is arranged in an arrangement direction BA.

The busbar module 100 includes a plurality of busbars 110, a case 120, a flat wiring member 3, a connector 50, and a protector 1. The busbar 110 can be connected to an electrode of the battery cell 220. The busbar 110 connects electrodes of two adjacent battery cells 220 to each other, for example.

The case 120 accommodates the plurality of busbars 110 and a part of the flat wiring member 3. The case 120 is formed of an insulating synthetic resin, for example. The case 120 includes a holder that holds the busbar 110. The plurality of busbars 110 is arranged and held in the arrangement direction BA by the case 120. The case 120, in a state of holding the plurality of busbars 110 and the flat wiring member 3, is fixed to the battery module 210.

When the flat wiring member 3 is a flexible printed circuit board, the flat wiring member 3 includes a base film, a conductive layer, and a coverlay. The conductive layer is sandwiched and protected by the base film and the coverlay. The conductive layer is, for example, a conductive metal foil, and has a circuit pattern including a plurality of detection lines. The detection line is connected to the corresponding busbar 110 or a thermistor. The detection line is connected to a monitoring unit 230 of the battery pack 200 via the connector 50. The monitoring unit 230 is disposed, for example, on an end surface of the battery module 210 in the arrangement direction BA.

The protector 1 is disposed, for example, at an end of the case 120 in the arrangement direction BA. The flat wiring member 3 is routed from the case 120 to the connector 50 via the protector 1.

As illustrated in FIGS. 2 and 3, the protector 1 of the present embodiment includes a first case 10, a second case 20, and a slide body 40. In each of diagrams such as FIGS. 2 and 3, a cover 22 of the first case 10 and a cover 42 of the slide body 40 are each illustrated in an opened state. When the protector 1 is actually used, the covers 22 and 42 are closed.

As illustrated in FIGS. 2 and 3, the second case 20 is rotatable relative to the first case 10. Therefore, the protector 1 of the present embodiment can allow the flat wiring member 3 to be extended from the second case 20 in a desired direction.

As illustrated in FIG. 4, the first case 10 includes a first passage 11, a busbar-side passage 12, projections 13 and 14, and a support shaft 15. The first case 10 is formed of an insulating synthetic resin, for example.

The busbar-side passage 12 can accommodate the flat wiring member 3 and extends in the arrangement direction BA. The busbar-side passage 12 is disposed adjacent to an end of the case 120. The busbar-side passage 12 is connected to an end of the case 120 in the arrangement direction BA. The busbar-side passage 12 may be configured as a part of the case 120, may be engaged with an end of the case 120, or may be fixed to the battery module 210 or the like so as to be adjacent to the end of the case 120.

The busbar-side passage 12 has a bottom wall 12a and a side wall 12b. The side wall 12b, provided as a pair, is disposed at either end in the width direction of the bottom wall 12a and extends in the arrangement direction BA. The bottom wall 12a has a projection 14 that locks the flat wiring member 3. The projection 14 is inserted into a through hole of the flat wiring member 3.

The first passage 11 extends in a first direction X. The first direction X is a direction orthogonal to the arrangement direction BA. The first direction X is a direction in which the flat wiring member 3 is routed in the first passage 11 and extends. A direction orthogonal to both the first direction X and the arrangement direction BA is denoted as a “second direction Y”. The second direction Y is a width direction of the flat wiring member 3 routed in the first passage 11.

The first passage 11 has a bottom wall 11a and a pair of side walls 11b. The shape of the bottom wall 11a is rectangular, for example. An end of the bottom wall 11a in the first direction X is connected to the bottom wall 12a of the busbar-side passage 12. The pair of side walls 11b is disposed on either side of the bottom wall 11a in the second direction Y. The side wall 11b extends in the first direction X. The bottom wall 11a and the pair of side walls 11b form a groove for accommodating the flat wiring member 3. The bottom wall 11a has the projection 13. The projection 13 protrudes from the bottom wall 11a in the arrangement direction BA. The shape of the projection 13 in an illustrated example is a columnar shape.

The projection 13 has a function as a locking portion that locks the flat wiring member 3 and a function of guiding a guide hole 23 of the second case 20. The projection 13 is disposed, for example, at the center of the bottom wall 11a in the second direction Y.

The support shaft 15 is disposed at an end of the first passage 11 in the second direction Y. The support shaft 15 is inserted into a recess 24 of the second case 20 to rotatably support the second case 20. The illustrated shape of the support shaft 15 is a columnar shape. The support shaft 15 is connected to the side wall 11b so as to be positioned in the vicinity of the flat wiring member 3.

As illustrated in FIGS. 4 and 5, the second case 20 includes a second passage 21, a cover 22, a guide hole 23, a recess 24, and a slide groove 25. The second case 20 is formed of an insulating synthetic resin, for example. The second case 20 has an extending direction Ex and a width direction W. The extending direction Ex is a direction in which the flat wiring member 3 extends in the second passage 21. The width direction W is a width direction of the flat wiring member 3 routed in the second passage 21, and is orthogonal to the extending direction Ex.

The second passage 21 has a bottom wall 21a, a pair of side walls 21b, and an edge 21c. The shape of the bottom wall 21a is rectangular, for example. The pair of side walls 21b is disposed on either side of the bottom wall 21a in the width direction W. The side wall 21b extends in the extending direction Ex. The bottom wall 21a and the pair of side walls 21b form a groove for accommodating the flat wiring member 3.

The edge 21c is formed to enable formation of a folded portion on the flat wiring member 3. The edge 21c is disposed at an end of the bottom wall 21a in the extending direction Ex. The edge 21c is formed straight and extends in the width direction W from an end of one side wall 21b toward the other side wall 21b.

There is provided a cylindrical portion 26 at a corner of the second passage 21. The cylindrical portion 26 is disposed at a corner where the edge 21c and one side wall 21b intersect. The cylindrical portion 26 has a cylindrical shape having an axis 26x extending in the arrangement direction BA. The recess 24 is a through hole penetrating the cylindrical portion 26. That is, the axis 26x of the recess 24 is orthogonal to both the extending direction Ex and the width direction W. The cross-sectional shape of the cylindrical portion 26 orthogonal to the axis 26x is a substantially fan shape. That is, the cross-sectional shape of the cylindrical portion 26 has an arc-shaped portion. The axis 26x is located on an extension line of the edge 21c.

The guide hole 23 is formed in the bottom wall 21a. The guide hole 23 penetrates the bottom wall 21a. The shape of the guide hole 23 in plan view of the bottom wall 21a is an arc shape. The center of the arc of the guide hole 23 is the axis 26x, for example. One end of the guide hole 23 is a wall surface of the edge 21c. That is, the guide hole 23 extends from the edge 21c in the circumferential direction around the axis 26x.

The central angle of the arc of the guide hole 23 corresponds to the rotation range of the second case 20 with respect to the first case 10. The other end 23a of the guide hole 23 is disposed at the center of the bottom wall 21a in the width direction W. In this case, the arc of the guide hole 23 has a central angle of approximately 45 degrees.

The cover 22 is connected to the side wall 21b of the second passage 21 via a hinge 22a. The cover 22 covers a groove accommodating the flat wiring member 3 and protects the flat wiring member 3. The cover 22 has an engagement portion 22b that engages with the second passage 21. The second passage 21 has a frame-shaped engagement portion 21d into which the engagement portion 22b is inserted.

The pair of slide grooves 25 guides the slide body 40 in the extending direction Ex. The slide groove 25 is provided in the side wall 21b and penetrates the side wall 21b. The slide groove 25 extends from one end to the other end of the second passage 21.

The edge 21c of the second passage 21 is disposed so as to be able to support a first folded portion 32a of the flat wiring member 3. FIG. 8 illustrates a cross section taken along line VIII-VIII of FIG. 2. As illustrated in FIG. 8, the edge 21c is erected from the bottom wall 21a toward the arrangement direction BA. The edge 21c can form the first folded portion 32a in the flat wiring member 3. The first folded portion 32a has a curved shape protruding toward a first side X1 in the first direction X.

The first folded portion 32a is formed between a first portion 31a and a second portion 31b of the flat wiring member 3. The first portion 31a is a portion routed in the first passage 11 and extends in the first direction X. The second portion 31b is a portion routed in the second passage 21 and extends in the first direction X. The first folded portion 32a, the first portion 31a, and the second portion 31b form a substantially U shape so as to surround the bottom wall 21a.

As illustrated in FIG. 4, the slide body 40 includes a main body 41, a cover 42, a support wall 43, and a leg 44. The slide body 40 is formed of an insulating synthetic resin, for example. The main body 41 has a bottom wall 41a and a pair of side walls 41b. The shape of the bottom wall 41a is rectangular, for example. The pair of side walls 41b is disposed on either side of the bottom wall 41a in the width direction W. The side wall 41b extends in the extending direction Ex. The bottom wall 41a and the pair of side walls 41b form a groove for accommodating the flat wiring member 3.

The cover 42 is connected to the side wall 41b of the main body 41 via a hinge 42a. The cover 42 covers the groove accommodating the flat wiring member 3 and protects the flat wiring member 3. The cover 42 has an engagement portion 42b. The main body 41 has an engagement portion 41c corresponding to the engagement portion 42b.

The leg 44 is inserted into the slide groove 25 of the second case 20 and guided by the slide groove 25. The leg 44 protrudes from the side wall 41b in a direction orthogonal to the bottom wall 41a. There is provided a claw 44a at the tip of the leg 44. The claw 44a is locked by the side wall 21b of the second case 20.

The support wall 43 is connected to an end of the bottom wall 41a in the first direction X. The support wall 43 is a portion that supports an end 3b of the flat wiring member 3. The support wall 43 has a projection 43a that locks the flat wiring member 3.

As illustrated in FIG. 8, the slide body 40 holds the flat wiring member 3 so as to form a second folded portion 32b in the flat wiring member 3. The second folded portion 32b has a curved shape protruding toward a second side X2 in the first direction X. The second folded portion 32b is formed between the second portion 31b and a third portion 31c of the flat wiring member 3. The third portion 31c is a portion routed in the slide body 40 and extends in the first direction X. The second folded portion 32b, the second portion 31b, and the third portion 31c form a substantially U shape so as to surround the bottom wall 41a of the slide body 40.

FIG. 6 illustrates the second case 20 assembled to the first case 10. As illustrated in FIG. 6, the support shaft 15 of the first case 10 is inserted into the recess 24 of the second case 20. The support shaft 15 and recess 24 constitute a rotating structure 60. The rotating structure 60 is configured to be able to rotate the second case 20 relative to the first case 10.

The support shaft 15 has a columnar shape. At the tip of the support shaft 15, there is provided a projection 15a to avoid falling-out. The projection 15a is locked by the cylindrical portion 26. The second case 20 can rotate relative to the first case 10 about a central axis 15x of the support shaft 15 as a rotation center.

The projection 13 of the first case 10 is inserted into the guide hole 23 of the second case 20. The guide hole 23 guides the projection 13 and defines a movable range of rotation of the second case 20 relative to the first case 10. One end in the movable range is defined by the end 23a of the guide hole 23. The other end of the movable range is defined by the edge 21c. The edge 21c functions as a stopper that locks the projection 13.

There is provided a lock 13a at the tip of the projection 13. The lock 13a is a claw-shaped protrusion that protrudes from the outer peripheral surface of the projection 13. As illustrated in FIG. 6, the lock 13a faces the bottom wall 21a of the second passage 21 and is locked by the bottom wall 21a. The lock 13a protrudes in the radial direction of the arc in which the guide hole 23 extends. Therefore, when the second case 20 rotates relative to the first case 10, an overlap allowance of the lock 13a overlapping the bottom wall 21a is maintained at a constant size. This suppress the projection 13 from coming out of the guide hole 23, making it possible for the second case 20 to stably rotate with respect to the first case 10.

The recess 24 accommodates the support shaft 15 so as to make the support shaft 15 rotatable inside the recess 24. In the state of being accommodated in the recess 24, the position of the support shaft 15 is a position on an extension line of the edge 21c. The position of the central axis 15x of the support shaft 15 is preferably set on an imaginary line IL along the edge 21c. When the support shaft 15 is positioned in this manner, as described below, the flat wiring member 3 is less likely to be twisted, lifted, stretched, or the like when the second case 20 rotates.

FIG. 7 illustrates the second case 20 rotated from the position of FIG. 6. The extending direction Ex of the second case 20 is inclined with respect to the first direction X. That is, the protector 1 of FIG. 7 can extend the flat wiring member 3 in a direction intersecting the first direction X. The second case 20 can rotate relative to the first case 10 within a range allowed by the guide hole 23, making it possible to change the extension direction of the flat wiring member 3.

A rotational position at which the second case 20 rotates relative to the first case 10 has a predetermined rotational position. The predetermined rotational position is a rotational position illustrated in FIG. 6, and is a position where the projection 13 is locked by the end 23a of the guide hole 23. When the rotational position of the second case 20 is a predetermined rotational position, the extending direction Ex of the second case 20 is aligned with the first direction X. Accordingly, the flat wiring member 3 is folded back such that the extending direction of the first portion 31a and the extending direction of the second portion are parallel to each other.

As illustrated in FIG. 8, the protector 1 is configured to fold and hold the flat wiring member 3 in a substantially S-shape. The protector 1 forms the first folded portion 32a and the second folded portion 32b in the flat wiring member 3, and forms an extra length portion 30 in the flat wiring member 3. The rotational position of the second case 20 illustrated in FIG. 8 is the predetermined rotational position. At this time, as illustrated in FIG. 8, the edge 21c of the second case 20 supports the first folded portion 32a from the inside.

The slide body 40 can slide with respect to the second case 20 while being guided by the second case 20. The moving direction of the slide body 40 is the extending direction Ex of the second case 20. When the second case 20 is at the predetermined rotational position, the slide body 40 can move in the first direction X.

With the slide body 40 sliding with respect to the second case 20, the extra length portion 30 of the flat wiring member 3 can be extracted from the second passage 21. When the slide body 40 moves from the position illustrated in FIG. 8 toward the first side X1, the extra length portion 30 is extracted. On the other hand, when the slide body 40 moves toward the second side X2, the extracted extra length portion 30 is accommodated in the second passage 21.

FIG. 9 illustrates the flat wiring member 3 when the second case 20 is at the rotational position of FIG. 7. The second case 20 rotates relative to the first case 10 while holding the second portion 31b of the flat wiring member 3. The second portion 31b is accommodated in a space formed by the second passage 21 and the slide body 40, and is held by the second passage 21. In the protector 1 of the present embodiment, the end 3d of the flat wiring member 3 is further held by the slide body 40. That is, the flat wiring member 3 is held by both the second passage 21 and the slide body 40.

With the rotation of the second case 20 relative to the first case 10, the second portion 31b of the flat wiring member 3 rotates relative to the first portion 31a. This operation changes an intersection angle θ as illustrated in FIG. 9. The intersection angle θ is an angle at which the second portion 31b intersects the first portion 31a. In other words, the intersection angle θ is an angle formed by the first direction that is the extending direction of the first portion 31a, and the extending direction Ex of the second portion 31b. The first folded portion 32a of the flat wiring member 3 follows the rotation of the second case 20 while being deformed so as to change the intersection angle θ.

In the protector 1 of the present embodiment, the central axis 15x of the support shaft 15 is located on the imaginary line IL. With this configuration, as described below, the flat wiring member 3 is less likely to be twisted, lifted, stretched, or the like when the second case 20 rotates to deform the flat wiring member 3.

FIG. 10 illustrates the flat wiring member 3 when the intersection angle θ is 0 [deg]. The rotational position of the second case 20 when the intersection angle θ is 0 [deg] is the predetermined rotational position. At this time, the flat wiring member 3 is folded back such that the first direction X, which is the direction in which the first portion 31a extends, and the extending direction Ex of the second portion 31b are parallel to each other. When the intersection angle θ is 0 [deg], the edge 21c of the second passage 21 supports the first folded portion 32a from the inside. At this time, the edge 21c can define the position and shape of the first folded portion 32a.

FIG. 11 illustrates the flat wiring member 3 when the rotational position of the second case 20 is different from the predetermined rotational position. The intersection angle θ has a value different from 0 [deg]. The flat wiring member 3 deforms the first folded portion 32a so as to be inclined with respect to the second direction Y. The flat wiring member 3 is deformed such that a part of the first portion 31a in FIG. 10 goes around the edge 21c and changes to the second portion 31b. At this time, a gap may be formed between the first folded portion 32a and the edge 21c.

In the protector 1 of the present embodiment, the central axis 15x is located on the imaginary line IL. Therefore, when the second case 20 rotates, the flat wiring member 3 can be easily deformed while following the second case 20. As illustrated in FIG. 11, the flat wiring member 3 is deformed around a point 3a. The point 3a is an end of the first folded portion 32a on the central axis 15x side. Before and after the second case 20 rotates, deformation amount is small at the portion of the point 3a. The deformation amount is great at the portion of the first folded portion 32a on the side opposite to the point 3a. By such deformation, the flat wiring member 3 can easily follow the rotation of the second case 20.

Next, another example of the rotating structure 60 according to the embodiment will be described. FIGS. 12 and 13 illustrate a rotating structure 60 including a pair of guide grooves 16 and a pair of protrusions 27. The pair of guide grooves 16 is disposed in the first case 10, for example. In this case, the pair of protrusions 27 is disposed in the second case 20.

The guide groove 16 is an arc-shaped groove and guides the corresponding protrusion 27 along an arc-shaped track. The first case 10 has a guide wall 17 having the guide groove 16. The guide groove 16 penetrates the guide wall 17. The guide wall 17 is, for example, a wall connected to a side surface of the first passage 11 as illustrated in FIG. 14. As illustrated in FIG. 14, the two guide grooves 16 are disposed concentrically. In other words, the center of the arc of one guide groove 16 matches the center of the arc of the other guide groove 16. The rotation center Cx about which the second case 20 rotates is located at the center of the arc of the guide groove 16. The two guide grooves 16 in FIG. 13 are disposed line-symmetrically with respect to a straight line in the first direction X passing through the rotation center Cx.

As illustrated in FIG. 12, the protrusion 27 protrudes from the side wall 21b of the second case 20 in a direction orthogonal to the bottom wall 21a. The protrusion 27 is formed in a plate shape that can be inserted into the guide groove 16. There is provided a claw 27a at the tip of the protrusion 27. The claw 27a is locked by the guide wall 17.

FIG. 15 illustrates the flat wiring member 3 when the second case 20 is at a predetermined rotational position. At this time, the first folded portion 32a of the flat wiring member 3 extends in the second direction Y. The second case 20 can rotate clockwise or counterclockwise with respect to the first case 10 from the predetermined rotational position.

FIG. 16 illustrates the flat wiring member 3 when the rotational position of the second case 20 is a position different from the predetermined rotational position. That is, the intersection angle θ has a value different from 0 [deg]. The two guide grooves 16 can guide the two protrusions 27 to rotate the second case 20 relative to the first case 10. The rotation center Cx of the second case 20 is an intermediate position between the two protrusions 27. The rotation center Cx in FIG. 16 is the center of the flat wiring member 3 in the width direction. With the rotation of the second case 20 relative to the first case 10, the extension direction of the flat wiring member 3 can be set to a desired direction.

Note that the rotation center Cx is not limited to the center of the flat wiring member 3 in the width direction. The rotation center Cx may be set, for example, at an end of the flat wiring member 3 in the width direction. In the second case 20 of FIG. 17, the two protrusions 27 are disposed such that the rotation center Cx is located at an end of a routing path 21e to be described below.

As illustrated in FIG. 17, the second case 20 has a widened portion 28. The widened portion 28 is a portion obtained by widening a part of the second passage 21 toward the width direction W. The second passage 21 has a routing path 21e. The routing path 21e is a routing path assumed as a region in which the second portion 31b of the flat wiring member 3 is routed. The routing path 21e is set in the extending direction Ex. The widened portion 28 is disposed at an end of the second passage 21 in the extending direction Ex and protrudes in the width direction W with respect to the routing path 21e.

One protrusion 27 of the two protrusions 27 is disposed in the widened portion 28. The two protrusions 27 are disposed such that the rotation center Cx is located at the end of the routing path 21e in the width direction W. The two protrusions 27 are disposed on the imaginary line IL along the edge 21c. When the second case 20 in FIG. 17 rotates relative to the first case 10, the first folded portion 32a extends in the radial direction about the rotation center Cx. Therefore, the deformation of the flat wiring member 3 is similar to the deformation illustrated in FIG. 9.

Note that the two guide grooves 16 may have arc shapes with different radii. FIG. 18 illustrates two guide grooves 16 having different radii. The two guide grooves 16 have a first guide groove 16a and a second guide groove 16b. The first guide groove 16a has a relatively small radius R1, and the second guide groove 16b has a relatively large radius R2. The first guide groove 16a and the second guide groove 16b are disposed concentrically. A guide wall 17a having the first guide groove 16a is disposed closer to the rotation center Cx than a guide wall 17b having the second guide groove 16b.

For example, the first guide groove 16a and the second guide groove 16b are disposed such that the rotation center Cx is located at the end of the routing path 21e. The rotation center Cx may be located on the imaginary line IL. The imaginary line IL in FIG. 18 is a straight line along the edge 21c of the second case 20.

In the rotating structure 60 having the two guide grooves 16 and the two protrusions 27, the position of the rotation center Cx can be set to a desired position by both making the radii of the two guide grooves 16 different and adjusting the positions of the two guide grooves 16.

As described above, the protector 1 of the present embodiment includes the first case 10, the second case 20, and the rotating structure 60. The first case 10 has a first passage 11 through which the first portion 31a of the flat wiring member 3 is routed. The second case 20 has a second passage 21 through which the second portion 31b of the flat wiring member 3 is routed. The rotating structure 60 is configured to be able to rotate the second case 20 relative to the first case 10.

The second case 20 holds the second portion 31b so as to form a folded portion between the first portion 31a and the second portion 31b. The rotating structure 60 is configured such that the rotation of the second case 20 relative to the first case 10 changes the intersection angle θ of the second portion 31b with respect to the first portion 31a at the folded portion. The protector 1 of the present embodiment is capable of changing the extension direction of the flat wiring member 3. The extension direction of the flat wiring member 3 in the embodiment is the extending direction Ex of the second case 20.

The protector 1 can handle a case where the arrangement of the mating connector is different in the device to be applied. The mating connector is provided in the monitoring unit 230, for example. In the protector 1 of the present embodiment, even when the direction of the mating connector with respect to the protector 1 is irregular, the second case 20 can be rotated to extend the flat wiring member 3 toward the mating connector. Therefore, according to the protector 1 of the present embodiment, the common protector 1 can be applied to a plurality of devices having mating connectors at irregular positions, and the number of product numbers related to the protector 1 can be reduced.

The rotating structure 60 includes: the recess 24 disposed in the second case 20; and the support shaft 15 disposed in the first case 10 and inserted into the recess 24, for example. The rotating structure 60 rotates the second case 20 relative to the first case 10 about the central axis 15x of the support shaft 15 as a rotation center. The recess 24 may be disposed in the first case 10. In this case, the support shaft 15 is disposed in the second case 20.

The rotating structure 60 includes: a pair of guide grooves 16 having an arc shape and disposed in the first case 10; and a pair of protrusions 27 disposed in the second case 20 and inserted into the guide grooves 16, for example. The rotating structure 60 guides the protrusion 27 along the guide groove 16 to rotate the second case 20 relative to the first case 10. The guide groove 16 may be disposed in the second case 20. In this case, the protrusion 27 is disposed in the first case 10.

The second case 20 of the present embodiment has the edge 21c having a straight shape and capable of supporting the folded portion from the inside. The rotational position at which the second case 20 rotates relative to the first case 10 includes a predetermined rotational position. When the rotational position of the second case 20 is the predetermined rotational position, the flat wiring member 3 is folded back such that the extending direction of the first portion 31a and the extending direction of the second portion 31b are parallel to each other. The edge 21c may be disposed so as to support the folded portion from the inside when the rotational position of the second case 20 is the predetermined rotational position. In this case, the rotation center Cx at which the second case 20 rotates relative to the first case 10 is preferably located on a line along the edge 21c. An example of the line along the edge 21c is the imaginary line IL in the embodiment. With this arrangement of the rotation center Cx, the flat wiring member 3 is less likely to be twisted, lifted, stretched, or the like when the second case 20 rotates.

The busbar module 100 of the present embodiment includes the protector 1, the flat wiring member 3, the connector 50, and the plurality of busbars 110. The connector 50 and the busbar 110 are connected to the flat wiring member 3. The busbar 110 can be connected to an electrode of the battery cell 220. In the busbar module 100 of the present embodiment, even when the monitoring unit 230 is located at an irregular position with respect to the protector 1, the flat wiring member 3 can be extended toward the monitoring unit 230.

The range in which the second case 20 rotates relative to the first case 10 is not limited to the exemplified range. The rotation range of the second case 20 may be 90 [deg] or 180 [deg]. When the rotation range of the second case 20 is 180 [deg], the rotating structure 60 may be configured to allow the second case 20 to rotate in both the clockwise direction and the counterclockwise direction with respect to the predetermined rotational position.

The protector 1 need not include the slide body 40. Referring to FIG. 8, when the protector 1 does not include the slide body 40, the protector 1 need not form the second folded portion 32b in the flat wiring member 3. In this case, the flat wiring member 3 may extend from the second case 20 toward the second side X2. When the protector 1 does not include the slide body 40, the extension direction of the flat wiring member 3 with respect to the second case 20 is not limited to the extending direction Ex. The flat wiring member 3 may extend in the width direction W from the second case 20.

The protector 1 may include a third case in addition to the first case 10 and the second case 20. In this case, the protector 1 may have a second rotating structure that rotates the third case relative to the second case 20. The third case holds the flat wiring member 3 so as to form a third folded portion on the flat wiring member 3. The second rotating structure is configured such that the rotation of the third case relative to the second case 20 changes an intersection angle at the third folded portion.

The second rotating structure may include: a recess disposed in one case out of the second case 20 and the third case; and a support shaft disposed in the other case out of the two cases. The second rotating structure may include: a guide groove disposed in one case out of the second case 20 and the third case; and a protrusion disposed in the other case out of the two cases.

The contents disclosed in the above embodiment can be executed in appropriate combination with each other.

In the protector according to the present embodiment, the rotating structure is configured to change the intersection angle of the second portion with respect to the first portion at the folded portion of the flat wiring member by the rotation of the second case relative to the first case. According to the protector of the present embodiment, it is possible to change the extension direction of the flat wiring member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a first case including a first passage through which a first portion of a flat wiring member is routed;
a second case including a second passage through which a second portion of the flat wiring member is routed; and
a rotating structure configured to be able to rotate the second case relative to the first case,
wherein the second case holds the second portion so as to form a folded portion between the first portion and the second portion, and
the rotating structure is configured such that rotation of the second case relative to the first case changes an intersection angle of the second portion with respect to the first portion at the folded portion.

2. The protector according to claim 1, wherein
the rotating structure includes: a recess disposed in one case out of the first case and the second case; and a support shaft disposed in the other case out of the first case and the second case and inserted into the recess, and
the rotating structure rotates the second case relative to the first case about a central axis of the support shaft as a rotation center.

3. The protector according to claim 1, wherein
the rotating structure includes: a pair of guide grooves having an arc shape and disposed in one case out of the first case and the second case; and a pair of protrusions disposed in the other case out of the first case and the second case and inserted into the guide grooves, and
the rotating structure guides the protrusions along the guide grooves to rotate the second case relative to the first case.

4. The protector according to claim 2, wherein
the second case has an edge having a straight shape and capable of supporting the folded portion from inside,
a rotational position at which the second case rotates relative to the first case includes a predetermined rotational position,
the flat wiring member is folded back, when the rotational position of the second case is the predetermined rotational position, such that an extending direction of the first portion and an extending direction of the second portion are parallel to each other,
the edge is disposed so as to support the folded portion from the inside when the rotational position of the second case is the predetermined rotational position, and
the rotation center at which the second case rotates relative to the first case is located on a line along the edge.

5. The protector according to claim 3, wherein
the second case has an edge having a straight shape and capable of supporting the folded portion from inside,
a rotational position at which the second case rotates relative to the first case includes a predetermined rotational position,
the flat wiring member is folded back, when the rotational position of the second case is the predetermined rotational position, such that an extending direction of the first portion and an extending direction of the second portion are parallel to each other,
the edge is disposed so as to support the folded portion from the inside when the rotational position of the second case is the predetermined rotational position, and
the rotation center at which the second case rotates relative to the first case is located on a line along the edge.

6. A busbar module comprising:
the protector according to claim 1;
the flat wiring member;
a connector connected to the flat wiring member; and
a plurality of busbars connected to the flat wiring member and connectable to an electrode of a battery cell.
